(19) United States
(12) Patent Application Publication
(10) Pub. No.: US 2026/0289781 A1
(43) Pub. Date: Sep. 24, 2026

(54) DISSECTION APPARATUS

(71) Applicant: XYALL B.V., Eindhoven (NL)

(72) Inventors: Reinhold WIMBERGER-FRIEDL, Eindhoven (NL); Ruben KWANT, Eindhoven (NL); Nicole Catharina Elisabeth HAAZEN, Best (NL)

(21) Appl. No.: 19/474,881

(22) PCT Filed: Apr. 14, 2023
(86) PCT No.: PCT/EP2023/059825

§ 371 Date: Oct. 13, 2025

(51) Int. Cl. G06T 7/00; G06T 7/12

(52) U.S. Cl. CPC G06T 7/0014; G06T 7/12; G06T 2207/10056; G06T 2207/20104; G06T 2207/30024

(57) ABSTRACT

Some embodiments relate to a dissection apparatus including a dissection tool for dissecting biological material from an identified region of interest within a tissue sample disposed on a slide. The apparatus is equipped with a light source for illuminating the tissue sample and an imaging module, including an image sensor and an image processor, which is configured to capture a first image of the tissue sample prior to dissection, and to register an annotated boundary of the ROI onto the first image. The annotated boundary can be identified from a reference image of a corresponding reference sample. The imaging module is further configured to capture a second image of the tissue sample after dissection, whereby the image processor is programmed with an algorithm.

### CROSS-REFERENCE TO RELATED APPLICATIONS

This application is a national phase filing under 35 C.F.R. § 371 of and claims priority to PCT Patent Application No. PCT/EP2023/059825, filed on Apr. 14, 2023, the contents of which are hereby incorporated in its entirety by reference herein

### FIELD OF THE DISCLOSURE

The presently disclosed subject matter relates to an apparatus for dissecting biological material from a sample disposed on a planar substrate, such as a glass slide.

### BACKGROUND ART

For the purpose of molecular testing in oncology, parts of tissue sections are collected from a glass slide. In general, tissue is collected from several slides for a single case to have sufficient material for a molecular test. The region of interest (ROI) where the tissue is to be collected from is indicated by a pathologist on a reference image that is captured for a specific tissue section. The pathologist draws a line identifying the boundary of the ROI, which is typically referred to as annotation. The annotation for the reference image is then transferred to an image of each slide containing a further tissue section from the same sample that is to be dissected. This is typically referred to as registration of the reference image to the dissection image. After image registration, a dissection tool is controlled to mechanically remove biological material within the annotated boundary.

One example of an automated device for mechanically removing material from a biological sample is disclosed in WO 2012/102779. The device comprises an extraction tool, which has a rotating cutting tip for disrupting material from a region of the sample and a liquid dispensing port and a liquid aspiration port, located in close proximity to the cutting tip. The device is configured such that liquid is dispensed at the cutting tip and such that disrupted material and dispensed liquid are aspirated via the aspiration port into the extraction device.

It is also known to remove biological material via scraping using a dissection tool equipped with a scraping blade. An example of a dissection apparatus provided with such a dissection tool is disclosed in WO 2022/063695. The scraping blade is arranged at an orifice of the dissection tool and suction is applied during dissection, such that sample material detached via scraping is drawn into the orifice and an internal cavity of the tool, where it is collected at the underside of a filter element that spans the internal cavity.

As will be understood, it is important for the accuracy and quality of the molecular test result that the region of interest identified by the pathologist is exactly dissected from each slide. The accuracy of the dissection result is thus a key factor in the quality control of the process as a whole. For an automated process, it is important to be able to assess the achieved dissection result in an automated and reliable manner, so as to determine the usability of the dissected material and possibly identify defects that are indicative of misalignment issues and/or problems with the dissection tool which may be corrected for the future.

### SUMMARY OF THE DISCLOSURE

The presently disclosed subject matter resides in a dissection apparatus comprising a dissection tool for dissecting biological material from an identified region of interest (ROI) within a tissue sample disposed on a slide, whereby the apparatus is equipped with a light source for illuminating the tissue sample and an imaging module, comprising an image sensor and an image processor. The imaging module is configured to capture a first image of the tissue sample prior to dissection and to register an annotated boundary of the ROI onto the first image, whereby the annotated boundary is identified from a reference image of a corresponding reference sample.

The imaging module is further configured to capture a second image of the tissue sample after dissection, whereby the image processor is programmed with an algorithm which executes steps of:
detecting an achieved dissection boundary, based on a pixelwise comparison of the first and second images, to determine a change in intensity;
comparing the detected dissection boundary with the registered annotated boundary to determine at least one indicator that is representative of the achieved quality of the dissection result; and
generating a quality report that includes the at least one determined indicator of quality.

In one embodiment, the change in intensity between the pixels of the first and second images is determined based on transmission. The light source is then arranged below the tissue slide and transmitted light is detected by the image sensor. In a further embodiment, the change in intensity is determined based on reflection, whereby the light source is arranged above the tissue slide and the image sensor detects light reflected from the tissue sample. To enhance contrast, first and second filter elements such as crossed polarisers are suitably provided. A first filter element is arranged between the light source and the tissue slide and a second filter element is arranged between the image sensor and a lens of the imaging module.

After dissection and removal of material, the intensity of light that is detected for a particular pixel of the second image changes. When the optical arrangement comprises crossed polarizers, for example, the detected intensity for a pixel of the second image will be smaller than the intensity detected for a pixel of the first image having the same coordinates.

Thus, the intensity difference between pixels of the first and second images having the same coordinates is determined. Since images of unstained thin tissue sections can have a low contrast and highly variable brightness and contain artefacts, the change in intensity after dissection can be very small and noisy. The step of detecting the achieved dissection boundary therefore preferably comprises a number of sub-steps in which mathematical operations are performed on the determined intensity difference to eliminate noise and mathematically construct detected boundaries.

In a preferred embodiment, the algorithm executes a sub-step of normalizing the determined intensity difference between corresponding pixels of the first and second images. Suitably this is followed by morphological opening to eliminate noise from the normalised intensity difference. Next, dissected areas are identified by detecting connected components in the normalised intensity difference and thresholding the detected components based on size. Preferably, filtering is also applied to eliminate small islands.

In a following sub-step, edges of the identified dissected areas are determined and selected as detected dissection boundaries. Suitably, this involves the application of an edge detector, such as a Laplacian filter, followed by image thresholding to select large values. Otsu thresholding is one example of a suitable thresholding technique.

Preferably, the determined edges of the identified dissection areas are selected as a detected dissection boundary based on proximity to the annotated boundary using a maximum distance measure.

Once the achieved dissection boundary has been detected, it is compared with the registered annotated boundary. In some examples, this involves calculating a distance of each pixel on the detected boundary to a nearest point on the annotated boundary. From this calculation, one indicator of quality for the achieved dissection result that may be determined and reported is a mean deviation with respect to the annotated boundary. This is calculated from the mean of the absolute distances from each pixel on the detected boundary to the nearest point on the annotated boundary. When the mean deviation exceeds a predetermined threshold, the generated quality report may additionally indicate that the achieved dissection result is unsatisfactory, or is satisfactory when the criterion has been met.

Additionally or alternatively, the determined indicator of quality may be a local maximum deviation of the detected dissection boundary from the annotated boundary. Again, when the maximum distance exceeds a predetermined threshold, the generated quality report may additionally indicate that the achieved dissection result is unsatisfactory, or is satisfactory when the criterion has been met.

The step of comparing the detected dissection boundary with the annotated boundary may further comprise detecting a shift in the detected dissection boundary relative to the annotated boundary. Such a shift is indicative of a misalignment between the imaging module and a dissection module of the apparatus to which the dissection tool is attached. When such a shift is detected, this is suitably reported, together with a suggested corrective action of checking the alignment of imaging module relative to the dissection module. Likewise, a size change of the detected boundary with respect to the annotated boundary can be calculated. Such a size change can be indicative of a dissection tool misalignment and may be reported, together with a suggested corrective action. The image processing algorithm executes a further step of mapping the detected dissection boundary onto the annotated boundary in a best-fit operation, to obtain an associated transformation matrix. The transformation matrix which provides the best fit is then analysed to detect any shift or any change in size of the detected boundary relative to the annotated boundary, where present.

In other examples, a further indicator of quality that is determined from the comparison of the first and second images is a percentage of the ROI that has been dissected. Suitably, the algorithm executes a further step of determining an area of tissue material to be dissected, by identifying pixels in the first image, which lie within the registered annotated boundary, and which exhibit a predefined minimum level of brightness/intensity. An area of tissue material that has been dissected is determined by identifying corresponding pixels in the second image, which exhibit a change in intensity that exceeds a threshold value, which threshold is set based on a level of background intensity. Optionally the background level can be determined locally.

The percentage of the dissected area within the ROI relative to the area to be dissected can then be calculated and reported as a further indicator of quality for the achieved dissection result. As will be understood, a minimum value can be set for an acceptable percentage of tissue recovery from within the ROI, e.g. 97%, and when the calculated recovery lies below the minimum value, the generated quality report may additionally indicate that the achieved dissection result is unsatisfactory, or is satisfactory when the criterion has been met.

The advantage of additionally calculating the percentage of tissue that was dissected from within the ROI is that in cases where the detected dissection boundary accurately follows the registered annotated boundary, but areas of tissue within the ROI have not been dissected, an unsatisfactory dissection result can nonetheless be determined.

Pixels of the second image which lie outside of the annotated boundary and which exhibit a change in intensity above the threshold value may also be identified as a dissected area. The indicator of quality that is determined and reported may then further include the fraction of sample material from outside of the ROI that has been dissected, relative to the dissected area inside the ROI. This provides an indication of the extent to which the intended dissected tissue material has been diluted with unintended sample material.

The quality report may further indicate the presence of any islands of undissected material when the image processing algorithm detects the edges of such objects. In embodiments where the detected boundaries are selected based on proximity to the annotated boundary, such objects are excluded from the calculation of deviations of the detected boundary relative to the annotated boundary when the object is too far away from the annotated boundary. For example, if the distance between the object and the annotated boundary is more than a width of the dissection tool used in the dissection process.

The generated quality report may further include one or more additional outputs.

In some examples, the report includes the first image of a tissue slide, captured prior to dissection and the second image of the slide, captured after dissection. Preferably, the registered annotated boundary is also shown on the first and/or second images.

In further examples, the second image is shown with an overlay of the detected dissection boundary. When the at least one determined indicator of quality is a maximum local deviation, and the deviation exceeds the allowable threshold, parts of the detected boundary that exceed the threshold may additionally be highlighted.

The quality report may further include an indication that no dissection boundary could be detected or that no sample material has been removed, where applicable.

In addition to comparing the at least one determined indicator of quality with an acceptable threshold value, in order to indicate whether the achieved dissection result is satisfactory, the comparison with the threshold may also be used to assign a quality rating or score to that quality indicator. When more than one indicator of quality is determined, each indicator is preferably compared with an acceptable threshold and an overall quality rating for the achieved dissection result is calculated and reported.

In a further development, the step of image registration of the reference image and annotated boundary onto the dissection image (first image of a tissue slide) comprises determining a quality of the image registration. One example of a technique that may be applied is intersection over union, which quantifies how well the reference image maps onto the dissection image. A quality rating may thus be assigned and included in the overall quality rating.

As will be understood, the calculation and reporting of such an overall quality rating can provide an indication of whether or not the material dissected from a particular slide should be included in subsequent molecular testing.

In addition to generating a quality report for each dissected tissue slide in a case, the apparatus of the presently disclosed subject matter may also be configured to generate a report for the case as a whole. Suitably, the quality rating calculated for each slide is used to determine a quality rating for the case as a whole, which is useful in determining whether the sample material collected corresponds in principle to the selection of ROI made on the reference image.

An apparatus in accordance with the presently disclosed subject matter thus provides for automated determination and reporting of the achieved dissection result, the output of which is exceedingly valuable in a clinical environment. Moreover, the automated determination of the dissection result is not restricted to the use of any particular type of dissection tool. In some embodiments, the dissection tool comprises a scraping blade, such as described in WO 2022/063695. In other embodiments, the dissection tool is equipped with a milling tip, such as described in WO 2012/102779. In still further embodiments the dissection tool is a laser and the apparatus is configured for laser capture micro-dissection.

Other advantages will be explained in the following detailed description, with reference to the accompanying drawings.

### BRIEF DESCRIPTION OF THE DRAWINGS

The presently disclosed subject matter will now be further elucidated with reference to the embodiments described hereinafter. In the drawings,

FIG. 1a schematically shows a side view of a dissection apparatus according to the presently disclosed subject matter comprising a dissection tool and a first example of an optical arrangement for capturing images of tissue slides;

FIG. 1b schematically depicts an alternative optical arrangement;

FIG. 1c shows an example of a quality control report generated by the apparatus of FIG. 1a;

FIGS. 2a and 2b show examples of an image of a tissue sample, captured after dissection, with a detected dissection boundary and an annotated boundary superimposed on the image.

It should be noted that items which have the same reference numbers in different figures, have the same structural features and the same functions, or are the same signals. Where the function and/or structure of such an item has been explained, there is no necessity for repeated explanation thereof in the detailed description.

### DETAILED DESCRIPTION OF EMBODIMENTS

Pathology diagnostic investigation of biological material, such as tissue and cells, forms the basis for many treatment decisions, particularly in oncology. For example, genomic-based tests are performed in order to inform therapy selection for individual patients diagnosed with cancer. The biological material/tissue may be obtained from a biopsy or surgery. Typical tissue processing steps comprise, for example, formalin fixation and paraffin embedding. Such formalin-fixed, paraffin-embedded (FFPE) biological material is then cut into thin sections which are fixed onto glass slides. Other methods of obtaining and preparing tissue samples are known. For molecular testing, samples are selected from such sections to meet the test requirements. A pathologist identifies regions of interest (ROI) and the identified ROI of each tissue slide is then dissected to obtain sufficient material for molecular testing.

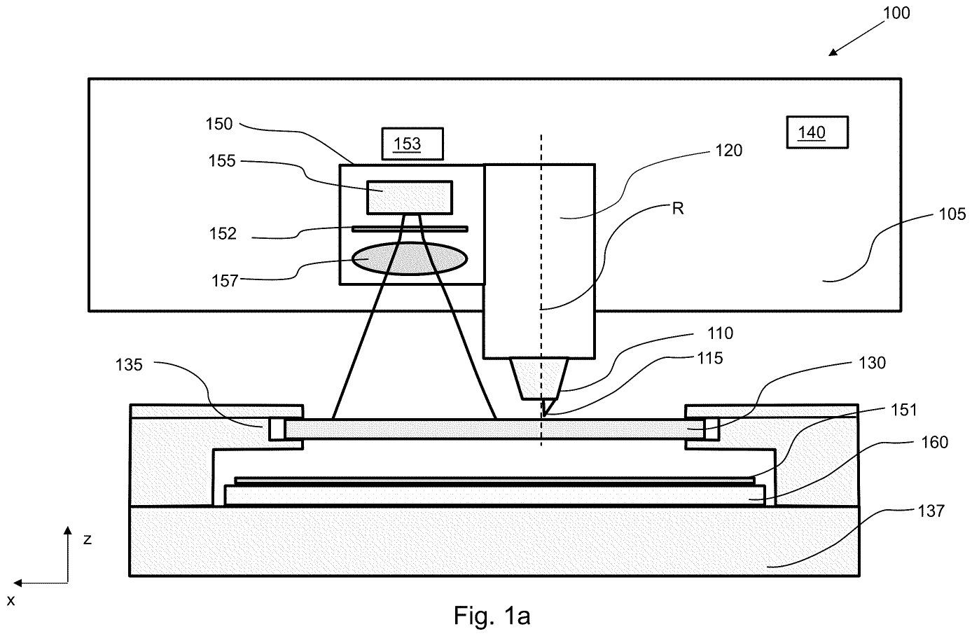

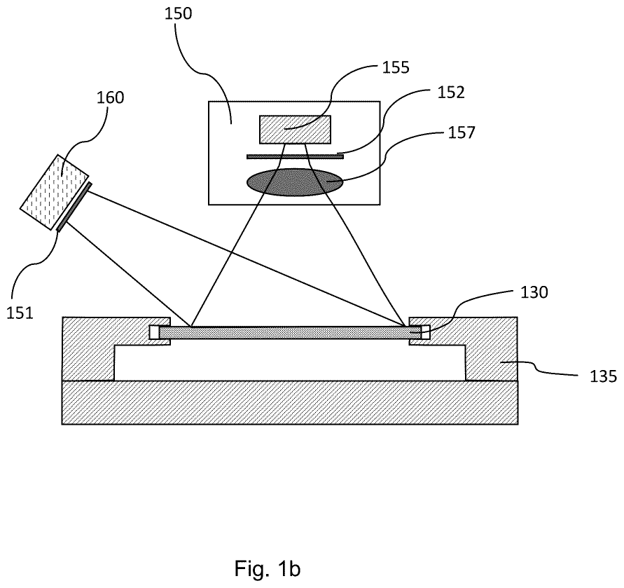

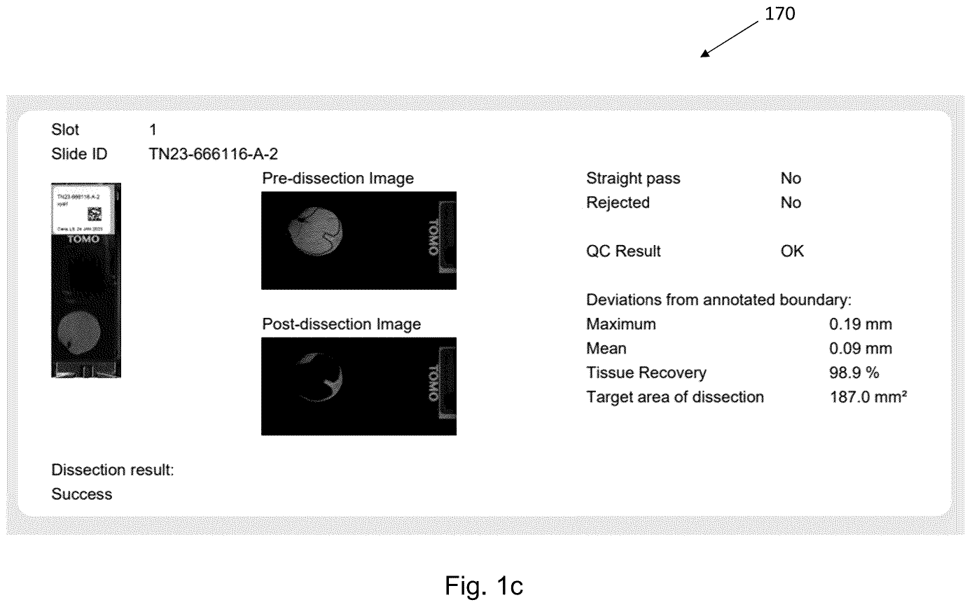

The presently disclosed subject matter relates to a dissection apparatus for automated dissection of sample material within identified regions of interest. An example of a dissection apparatus according to the presently disclosed subject matter is schematically depicted in FIG. 1a. The apparatus 100 comprises a dissection tool 110 attached to a robotic arm 120, which is mounted to a housing 105 of the apparatus.

The robotic arm 120 comprises a series of actuators for performing the necessary movements during dissection, which movements are controlled by a control unit 140 of the apparatus. Suitably, the robotic arm 120 comprises:
a rotary actuator, for rotating the tool around a vertical axis R that is normal to a platform 137 of the apparatus which supports a tissue slide 130 to be dissected;
an X-Y stage for translational movements and
a Z-stage for vertical movements. The Z-stage may comprise a hinge bearing for position control, to ensure that a constant and precise downward force is applied during dissection.

In the depicted example, the dissection tool 110 comprises a scraping blade 115 for mechanically detaching sample material from the tissue slide 130, which is preferably held fixed in a slide mount 135 to prevent any movement of the slide during dissection. Typically, the slide mount holds a number of tissue slides from the same case, and is automatically loaded onto the support platform 137 of the apparatus. The apparatus is further equipped with a vacuum generator (not shown) which generates an uplifting airflow at the scraping blade, so that scraped material gets suctioned into an internal cavity of the dissection tool 110.

The apparatus further comprises an imaging module/camera module 150 equipped with an image processor 153, which is configured to capture and process an image of each tissue slide 130. The imaging module has an image sensor 155 and a lens 157 and to facilitate image capture, the apparatus is further equipped with a light source 160 and contrast-enhancing filter elements 151, 152. In the depicted example, images are captured in transmission and the light source 160 is arranged below the glass tissue slide 130. A first filter element 151 is arranged between the light source 160 and the slide 130 and a second filter element 152 is arranged between the image sensor 155 and the lens 157. Suitably, the first and second filter elements are crossed polarizers.

An example of an alternative optical arrangement is depicted schematically in FIG. 1b, whereby the imaging module 150 is configured to capture images based on reflection. The light source 160 is arranged above the slide 130, and light which is reflected from the tissue on the slide 130 is detected by the image sensor 155 of the imaging module. Again, first and second filter elements are used to enhance contrast. The first element 151 is arranged between the light source 160 and the slide; the second element 152 is arranged between the image sensor 155 and the lens 157.

In one example of a suitable workflow for the dissection process, a batch of tissue slides from the same biopsy case are prepared. The tissue slides may contain paraffin-embedded tissue samples, which are subsequently deparaffinised and optionally stained. An H&E stained slide is included for reference and identification of the ROI. Other tissue slides in the batch may remain unstained. Suitably, the H&E reference slide is scanned by a high resolution scanner, to allow tumour cells to be identified, and the H&E image is made available to a pathologist for ROI selection and annotation of the ROI boundary or boundaries. Each tissue slide is then scanned by the imaging module 150 and the captured digital image of each slide is stored. The annotated ROI is then mapped onto the digital image of each tissue slide in the batch. Suitably, the image processor 153 is programmed with an image registration algorithm that automatically transfers the annotated ROI boundaries to the images of the other tissue slides. The coordinates of the transferred annotations are communicated to the control unit 140 and used to guide the movements of the robotic arm 120 and corresponding movements of the dissection tool 110 such that material is removed from the ROI on each tissue slide.

As will be understood, it is important to dissect the region of interest that has been selected by the pathologist with high precision and accuracy. In practice, a number of factors can affect the accuracy of the achieved dissection result. These factors include: the accuracy of the registration of the reference image to the dissection image; alignment of the imaging module and dissection tool; accuracy and precision of the scraping movement and cutting behaviour of the tissue.

For an automated process it is important to determine and assess the quality the achieved dissection result in an automated and reliable fashion, to determine whether the sample material which has been collected can lead to successful molecular testing. A dissection apparatus according to the presently disclosed subject matter is configured to analyse the quality of the dissection result by detecting the tissue area which has actually been dissected and comparing this with the annotated area indicated by the pathologist. The detection of dissected areas and their boundaries is based on the principle that removing tissue results in a local intensity difference between pixels of an image of a tissue sample before and after dissection.

The imaging module 150 is configured to capture a first image of each tissue slide prior to dissection and a second image of the slide after dissection is complete. As mentioned, each slide 130 is held fixed in the slide mount 135, to ensure that there is no movement of the slide during dissection and the first and second images are in alignment.

The image sensor 155 detects an intensity value for each pixel of the first image and for a corresponding pixel of the second image which has the same coordinates. The image processor 153 is programmed to determine the difference in intensity pixelwise.

Images of unstained thin tissue sections can have a low contrast and highly variable brightness. Tissue contrast depends on thickness, the imaging modality, and settings of the light source and camera. There may be a large difference in intensity, as the local tissue composition can vary significantly. Consequently, there is no ideal exposure time. Areas may be over- or under-illuminated. When using an illumination that highlights tissue, the change in intensity after dissection in areas that contained a low intensity tissue will be very small and noisy. The images can also be affected by dust or other particles present on the slide before and/or after dissection. It can also happen that regions of interest as annotated by a pathologist contain areas where no tissue is present.

These factors make it challenging to identify the boundaries of dissected areas in a robust and accurate manner. The image processor 153 is thus programmed with an algorithm for detecting the achieved dissection areas and boundaries.

An example of a suitable algorithm executed by the apparatus of FIG. 1a, comprises the following steps.

In a first step, the pixelwise intensity difference between the first and second images is calculated and normalized:

$${I}_{x , y} = ( {Ipr}_{x , y} - {Ipo}_{x , y} ) / {Ipr}_{x , y}$$

whereby
I_{x,y} is the normalized intensity difference for all locations with coordinates x, y Ipr_{x,y} is the pre-dissection intensity value detected for each pixel of the first image with coordinates x, y, and
Ipo_{x,y} is the post-dissection intensity value detected for each pixel of the second image with coordinates x, y

In a second step, dissected areas are determined. This suitably comprises sub-steps of:
a) performing morphological opening to eliminate noise from I_{x,y}
b) detecting connected components
c) thresholding the detected components based on size and, optionally
d) filtering to eliminate small islands in the detected components.

In a third step, edges of the determined dissected areas are detected. An edge detector such as a Laplacian filter is applied to identify regions of rapid intensity change. Other suitable edge detectors include Prewitt edge detection, Sobel edge detection, or Canny edge detection.

In a fourth step, image thresholding is applied to select large values in the detected edges. A fixed value may be used or a threshold value may be determined automatically via the application of a thresholding technique. Otsu thresholding is one example of a suitable thresholding technique. Other techniques which may be applied include Moments or Triangle thresholding.

The selected large values may be determined as the detected dissection boundaries.

Preferably, the detected boundaries are additionally selected based on proximity to the registered annotation boundary using a maximum distance measure. This has the advantage of eliminating false positives, given that detected edges which are too far away from the annotated boundary are significantly more likely to be errors. The maximum distance measure may be set based on the width of the dissection tool.

The apparatus of the presently disclosed subject matter is further configured to determine at least one indicator of the quality of the achieved dissection result and to generate a quality control report that includes this indicator of quality. Preferably, a number of quality indicators are determined and reported. The QC report may be displayed on a screen of the apparatus and/or other user interface and stored in a laboratory information management system.

The image processor 153 is further programmed to compare the detected dissection boundary with the registered annotated boundary. The image processing algorithm executes a further step of calculating a distance of each pixel on the detected boundary to a nearest point on the annotated boundary.

In one example, the indicator of quality that is determined from the calculation is the mean deviation from the annotated boundary, which is determined as a mean of absolute distances:

$$〈 D 〉 = 1 / N {\sum }_{i = 1}^{N} abs ( Di )$$

In a further example, the indicator of quality that is determined from the calculated distances between the annotated boundary and the detected boundary is a maximum deviation. Suitably, a histogram of the calculated distances is generated and the maximum deviation is determined using cut-off in the histogram to eliminate outliers. A cut-off at the 99 percentile may be used.

In a preferred embodiment, the image processor is further configured to determine the area of tissue which has been dissected from inside or outside of the registered annotated boundary. Dissected areas are determined by identifying pixels in the second, post-dissection image that exhibit a change in intensity above a threshold value. The threshold value is set based on a level of background intensity. One indicator of quality that may be determined and reported is the fraction/percentage of the area which has been dissected from the ROI, relative to the area of the ROI to be dissected.

The area of the ROI to be dissected is determined by identifying pixels in the first, pre-dissection image, which lie within the annotated boundary and which exhibit a high intensity. Such pixels are identified by setting a minimum value that may be defined based on the optical arrangement, the type of tissue sample to be dissected and the level of background intensity. The area of tissue which has been dissected from the ROI is determined by identifying corresponding pixels in the second, post dissection image which exhibit a change in intensity above the threshold value. The percentage of tissue that has been dissected from the ROI, is then calculated and reported as a further indicator of quality for the achieved dissection result. This is beneficial in cases where the comparison of the detected dissection boundary with the annotated boundary indicates minimal deviation, but areas/islands of tissue within the ROI have not been dissected. No change in intensity is detected for such islands, which affects the calculated percentage of tissue recovery from the ROI. Depending on the size of any such islands, it can thus be concluded that dissection result is unsatisfactory even when the boundary of the ROI has been accurately dissected.

Similarly, the dissected area that lies outside the ROI may be determined and reported. The dissected area outside the ROI is determined by identifying pixels in the second, post-dissection image that lie outside the annotated boundary and exhibit a change in intensity above the threshold value. This area may be related to the dissected area within the ROI, to provide an indication of the dilution of intended tissue with non-intended sample material. The fraction of the determined dissection area outside the ROI relative to the dissection area inside the ROI is thus a further indicator of quality for the achieved dissection result that may be determined and included in the generated report.

The quality control report that is generated may also comprise the first and second images of the slide, captured pre- and post-dissection, including an overlay of the annotated boundary. An example of a quality control 170 report is shown in FIG. 1c. The report was generated based on dissection of a deparaffinized tissue sample using a dissection apparatus with a scraping blade such as described with reference to FIG. 1a.

In addition to the slide ID and pre- and post-dissection images, with an overlay of the annotated boundary, the quality indicators that have been determined and reported are the mean and maximum deviations from the annotated boundary and the percentage of tissue that was dissected from within the annotated boundary, i.e. within the ROI. The actual area of material that was dissected is also reported.

The report further includes an indication of whether the quality of the achieved dissection result in the given example is acceptable.

Suitably, the image processor is programmed with threshold values for each of the determined indicators of quality. For example, the threshold for the maximum deviation from the annotated boundary may be set at 0.25 mm. The threshold for the mean deviation may be set at 0.1 mm. The threshold for acceptable tissue dissection from within the ROI may be set at a minimum of 97%.

Each determined indicator of quality is compared with the corresponding threshold and the achieved dissection result is reported to be successful when each determined indicator lies within the threshold.

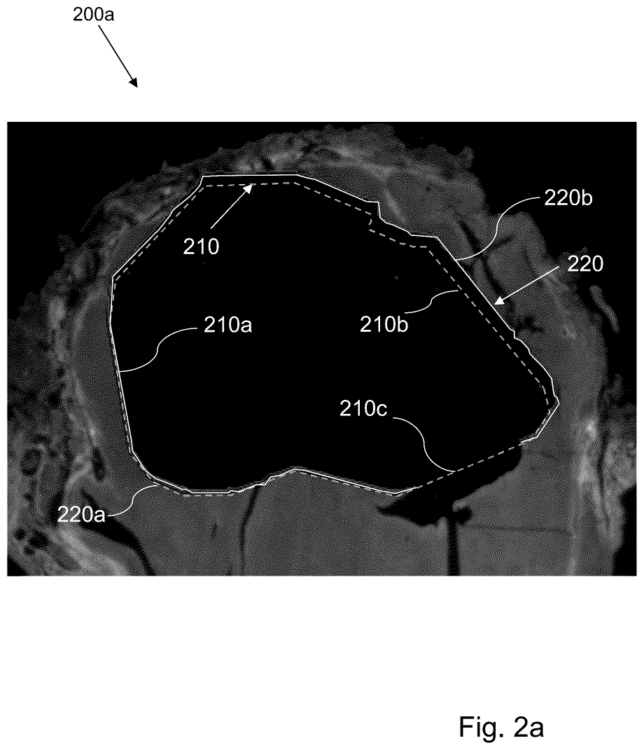

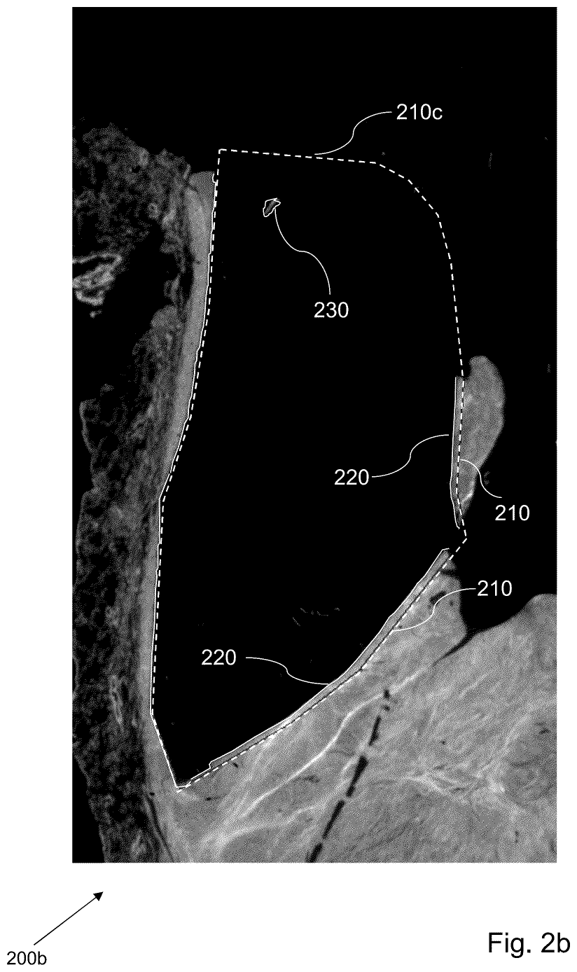

The generated quality report may further comprise a post-dissection image of a slide which shows the detected dissection boundary and the annotated boundary. An example of such an image 200a is depicted in FIG. 2a. Suitably, the detected boundary and the annotated boundary are shown using lines of different colour, e.g. red for the detected boundary and blue for the annotated boundary. In FIG. 2a, the annotated boundary 210 is indicated via the dashed line and portions thereof are indicated with reference numerals 210a, 210b and 210c. The detected dissection boundary 220 is indicated via the solid line and corresponding portions of the detected boundary are indicated with reference numerals 220a and 220b.

In the depicted example, the tissue sample is a deparaffinised sample dissected using a dissection apparatus with a scraping blade such as described with reference to FIG. 1a. A portion of the annotated boundary 210c lies in a region of the actual sample which contained no tissue. As a result, no dissection boundary could be detected in this region given that there would be no change in intensity before and after dissection. In the generally lower left region of the image, there is minimal deviation between the annotated boundary portion 210a and the detected boundary portion 220a. In the generally upper right region of the image, there is a significant deviation between the detected boundary portion 220b and the annotated boundary portion 210b. The mean deviation exceeds the threshold and the report will indicate that dissection has been unsuccessful. The reported image may further comprise highlighted sections where the maximum deviation has been exceeded.

In a further development, the step of comparing the detected boundary 220 and the annotated boundary 210 comprises identifying a shift of the detected dissection boundary 220 relative to the annotated boundary. When the area encompassed by the detected boundary largely corresponds with that of the annotated boundary, a shift in their respective centre-points is indicative of misalignment of the dissection module relative to the tool module. The generated quality report may include a separate indication of this, together with the suggestion to check the alignment of the tool module and the imaging module. Additionally or alternatively, such an identified shift and the suggested corrective action is reported separately in a maintenance report.

In other examples, it can happen that the dissected area is larger than the ROI, i.e. the detected boundary 220 exhibits a change in size relative to the annotated boundary 210. This can be indicative of tool misalignment. For example, a centre axis of the tool deviates from the vertical or possibly, the scraping blade is misaligned with respect to the tool centre axis. When such a size change is identified, the generated quality report may further include the area of material dissected from outside of the annotated boundary and suggest a corrective action such as checking the tool alignment. The suggested corrective action may also be reported separately in a maintenance report.

In order to identify a shift or size change of the detected boundary 220 relative to the annotated boundary, the algorithm is configured to execute a further step of mapping the detected dissection boundary 220 onto the annotated boundary 110 in a best-fit operation, to determine an associated transformation matrix that establishes a best fit between the two objects. When the detected boundary contains sufficient features to permit convergence, analysis of the transformation matrix enables a shift or size change of the detected boundary 220 relative to the annotated boundary to be identified.

In the example of FIG. 2a, although the detected boundary 210 has a “missing section” with regard to the portion 210c of the annotated boundary, it contains sufficient matching sections i.e. sufficient features to enable a reliable mapping and determination of a transformation matrix to be performed. In other cases, where large sections of the annotated boundary have no matching detected boundary (such as in the example of FIG. 2b), the identification of a shift/size change in the detected boundary relative to the annotated boundary may not be possible.

A further example of a post-dissection image 200b obtained for a different tissue sample is shown in FIG. 2b. Again, the tissue sample is a deparaffinised sample dissected using a dissection apparatus with a scraping blade such as described with reference to FIG. 1a. The annotated boundary 210, indicated via the dashed line, again comprises a portion 210c lying in a region of the actual sample which contained no tissue and no dissection boundary could be detected. Where tissue is present, a dissection boundary 220, indicated via the solid line, has been detected. The report may further indicate the fraction of the annotated boundary 210 that has a matching detected dissection boundary 220.

In a further development, the image processor is additionally configured to analyse the first image of a tissue slide that has been captured prior to dissection in order to detect tissue boundaries. This may be performed after the annotated boundary has been mapped onto the first image. A suitable image processing algorithm is applied to detect tissue and edges thereof and check if any detected edges lie inside the annotated boundary. This enables areas to be identified where detection of a boundary after dissection cannot be expected. An acceptable threshold may then be set for the fraction of the annotated boundary that has a matching detected dissection boundary and the quality control report includes an indication of whether the result is satisfactory.

In the example of FIG. 2b, the image processing algorithm has additionally detected edges of a small island 230 of undissected material lying inside the open portion 210c of the annotated boundary. The presence of the island 230 is visible in the post-dissection image that is shown in the quality report. The distance between the edges of the island and the annotated boundary is more than the width of the scraping blade used during dissection and has been excluded from the calculation of deviations in the detected dissection boundary 220 relative to the annotated boundary 210. As mentioned, the presence of the island also affects the calculated percentage of tissue recovery from the ROI and may lead to a determination that the dissection result is unsatisfactory.

In cases where no dissection boundary at all can be detected from the image processing of I_{x,y}, this is suitably included in the quality report.

One or more indicators of quality are determined and reported for each tissue slide in a particular case. In addition to an indication of whether a particular quality criterion has been met, e.g. the mean deviation between the detected boundary and the annotated boundary is less than a predefined maximum, a quality rating may also be assigned to each determined indicator of quality, such that an overall quality rating for the dissection result achieved for a particular slide is calculated. This provides an indication of whether the material dissected from that slide may be reliably used in the subsequent molecular testing. As will be understood, the rating calculated for each slide in a case may be used to calculate an overall quality rating for the case as whole, which is suitably reported in an additional report generated for the case as a whole.

As mentioned earlier, the accuracy/quality of the image registration can affect the achieved dissection result. In some embodiments, the apparatus is further configured to determine the quality of the registration of the reference image onto the first, pre-dissection image of a tissue slide. During the step of image registration, the image processor suitably quantifies the degree of overlap between the dissection image and the reference image by applying a technique such as Intersection over Union. Suitably, when the annotated boundary is mapped onto the dissection image of a tissue slide prior to dissection, the image processor is additionally programmed to assess the registration quality for the annotated ROI, instead of the full image. A quality rating is thus assigned to the image registration of each dissection slide, which may be reported separately in the quality report and used in the determination of the overall quality rating for a particular dissection slide.

Examples, embodiments or optional features, whether indicated as non-limiting or not, are not to be understood as limiting the presently disclosed subject matter as claimed. It should be noted that the above-mentioned embodiments illustrate rather than limit the presently disclosed subject matter, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The presently disclosed subject matter may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

### REFERENCE NUMERALS

100 dissection apparatus
105 apparatus housing
110 dissection tool
115 scraping blade of dissection tool
120 robotic arm comprising actuators for moving the dissection tool
130 tissue slide
135 slide mount
137 support platform of apparatus
140 control unit
150 imaging module
151, 152 contrast enhancing filter elements
153 image processor
155 image sensor
157 lens
160 light source
170 quality control report
200a, 200b image of tissue slide after dissection
210 registered annotated boundary
210a, 210b, 210c portions of annotated boundary
220 detected dissection boundary
220a, 220b portions of detected dissection boundary

1. A Dissection apparatus comprising a dissection tool for dissecting biological material from an identified region of interest within a tissue sample disposed on a slide, whereby the apparatus is equipped with a light source for illuminating the tissue sample and an imaging module, having an image sensor and an image processor, which is configured to:
capture a first image of the tissue sample prior to dissection; and
register an annotated boundary of the ROI onto the first image, which annotated boundary has been identified from a reference image of a corresponding reference sample,
wherein the imaging module is further configured to capture a second image of the tissue sample after dissection, and wherein the image processor is programmed with an algorithm which executes steps of:
detecting an achieved dissection boundary, based on a pixelwise comparison of the first and second images, to determine a change in intensity;
comparing the detected dissection boundary with the registered annotated boundary to determine at least one indicator that is representative of the achieved quality of the dissection result; and
generating a quality report that includes the at least one determined indicator.

2. The dissection apparatus of claim 1, wherein the step of detecting the achieved dissection boundary further includes:
normalizing the determined intensity difference between corresponding pixels of the first and second images;
detecting connected components in the normalized intensity difference, to identify dissected areas;
determining edges of the identified dissected areas by applying an edge-detection filter; and
selecting the determined edges as a detected dissection boundary.

3. The dissection apparatus of claim 2, wherein the step of determining edges of the identified dissected areas further includes the application of image thresholding, to identify large values, and wherein the identified large values are selected as a detected dissection boundary.

4. The dissection apparatus of claim 3, wherein the step of detecting the achieved dissection boundary further includes selecting the determined edges of the identified dissection areas as a detected boundary based on proximity to the annotated boundary using a maximum distance measure.

5. The dissection apparatus of claim 1, wherein the step of comparing the detected dissection boundary with the annotated boundary includes calculating a distance of each pixel on the detected boundary to a nearest point on the annotated boundary.

6. The dissection apparatus of claim 5, wherein the at least one indicator of achieved quality is:
a mean deviation of the detected dissection boundary from the annotated boundary, which is calculated from a mean of the absolute distances from each pixel on the detected boundary to the nearest point on the annotated boundary; or
a local maximum distance of the detected dissection boundary from the annotated boundary;

7. The dissection apparatus of claim 6, wherein the step of comparing the detected dissection boundary with the annotated boundary further comprises calculating a percentage of the annotated boundary which has a matching detected dissection boundary and wherein the generated quality report includes the calculated percentage.

8. The dissection apparatus of claim 1, wherein the image processing algorithm executes further steps of:
determining an area of tissue within the ROI to be dissected, by identifying pixels in the first image, which lie within the annotated boundary and exhibit an intensity above a pre-determined minimum value;
determining an area of tissue that has been dissected from the ROI by identifying corresponding pixels in the second image that exhibit a change in intensity above a threshold value, which threshold is set based on a level of background intensity; and
determining a percentage of the tissue area which has been dissected from the ROI, and wherein the generated quality report includes the determined percentage as a further indicator of quality for the achieved dissection result.

9. The dissection apparatus of claim 8, wherein the image processing algorithm executes further steps of:
determining an area of material that has been dissected outside the ROI by identifying pixels in the second image that exhibit a change in intensity above the threshold value, and which lie outside of the annotated boundary, and
calculating a fraction of the dissected area outside the ROI relative to the dissected area inside the ROI;
and wherein the generated quality report includes the determined fraction as a further indicator of quality for the achieved dissection result.

10. The dissection apparatus of any preceding claim 1, wherein the step of comparing the detected dissection boundary with the annotated boundary further comprises:
mapping the detected dissection boundary onto the annotated boundary in a best fit operation, to obtain an associated transformation matrix; and
analysing the transform matrix to identify a shift in the detected boundary relative to the annotated boundary or a change in size of the detected boundary relative to the annotated boundary;
and wherein the apparatus is further configured to report any such identified shift, together with a suggested corrective action of checking the alignment of the imaging module relative to the dissection tool, and to report any such identified size change, together with a suggested corrective action of checking the alignment of the dissection tool.

11. The dissection apparatus of claim 1, wherein the generated quality report further includes one or more outputs selected from:
the first image and the second image, including an overlay of the registered annotated boundary;
an overlay of the detected dissection boundary on the second image; and
an indication that no dissection boundary could be detected.

12. The dissection apparatus of claim 1, wherein the algorithm executes a further step of comparing the at least one determined indicator of quality with an acceptable threshold value and wherein the generated quality report further includes a rating for that indicator of quality and/or includes an indication of whether the achieved dissection result is satisfactory, based on the comparison.

13. The dissection apparatus of claim 12, wherein each determined indicator of quality is compared with an acceptable threshold value and wherein the generated quality report further includes an overall rating for the quality of the achieved dissection result.

14. The dissection apparatus of claim 13, wherein the image processor is further configured to determine a quality of the image registration, by quantifying a degree of overlap between the reference image and the first image of a tissue slide, and wherein the determined image registration quality forms part of the overall quality rating.
